(19) United States
(12) Patent Application Publication
(10) Pub. No.: US 2005/0224622 A1
(43) Pub. Date: Oct. 13, 2005

(54) Dual level load limiting belt retractor with improved load switching

(76) Inventor: Jeffry N. Zolkower, West Bloomfield, MI (US)

Correspondence Address: DELPHI TECHNOLOGIES, INC., M/C 480-410-202, PO BOX 5052, TROY, MI, 48007, US

(21) Appl. No.: 10/812,473

(22) Filed: Mar. 30, 2004

(51) Int. Cl. B60R 22/36

(52) U.S. Cl. 242/379.1; 242/382

(57) ABSTRACT

A seat belt restraint system includes a dual level load limiting belt retractor that has a high level load limit and a low level load limit resisting paying-out the belt when the belt retractor is locked. The belt retractor includes an auxiliary load limit mechanism for assisting in the pay-out resistance when operation is changed from the high level load limit to the low level load limit.

### FIELD OF THE INVENTION

This invention relates generally to dual level load limiting belt retractors.

### BACKGROUND OF THE INVENTION

U.S. Pat. No. 6,648,260 B2 granted to James Lloyd Webber et al. Nov. 18, 2003 discloses a dual level load limiting belt retractor. The retractor includes a take-up spool connected to the belt of a seat belt restraint system that is locked in response to a predetermined deceleration. The belt retractor includes a high level torsion bar that permits withdrawal of the belt responsive to a high belt load after the retractor is locked and a low level torsion bar that permits withdrawal of the belt responsive to a lesser load. The belt retractor also includes a switch mechanism for switching operation from the high level torsion bar to the low level torsion bar to provide digressive load limiting on the belt when the retractor is locked.

### SUMMARY OF THE INVENTION

The invention provides a dual level load limiting belt retractor that improves the operation of the belt retractor in the operating transition from a high level load resistance to a low level load resistance.

### BRIEF DESCRIPTION OF THE DRAWINGS

FIG. 1 is a perspective view of a dual level load limiting belt retractor, according to the present invention, illustrated in operational relationship with a seat belt restraint system of a vehicle.

FIG. 2 is an exploded perspective view of the dual level load limiting belt retractor of FIG. 1.

FIG. 3 is a front view of the dual level load limiting belt retractor of FIG. 1 shown in a first operative state with a side cover removed.

FIG. 4 is a front view of the dual level load limiting belt retractor of FIG. 1 shown in a second operative state with the side cover removed.

FIG. 5 is a longitudinal section taken along the line 5-5 of FIG. 1 looking in the direction of the arrows.

FIG. 6 is a chart showing the retractor load and belt displacement over time of a prior art arrangement.

FIG. 7 is a front view of an auxiliary load limit mechanism of the belt retractor shown in a first state.

FIG. 8 is a front view of the auxiliary load limit mechanism shown in a second state.

FIG. 9 is a chart showing the retractor load and belt displacement over time of the dual level load limiting belt retractor of the invention.

### DETAILED DESCRIPTION OF PREFERRED EMBODIMENT

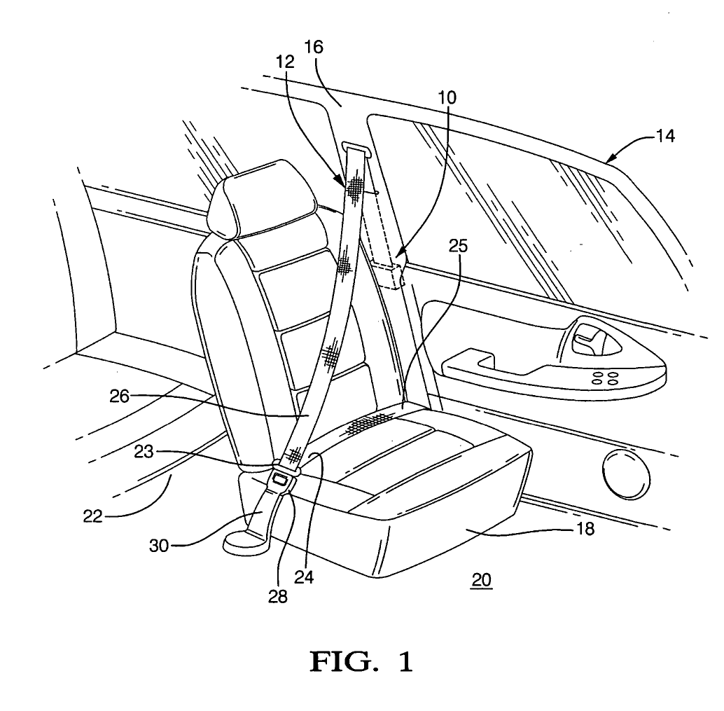

Referring to the drawings and in particular to FIG. 1, one embodiment of a dual level load limiting belt retractor 10, according to the present invention, is shown in operational relationship with a seat belt restraint system, generally indicated at 12, in a vehicle (partially shown), generally indicated at 14. The vehicle 14 includes a vehicle body 16 and a seat 18 mounted by suitable means to vehicle structure 20 such as a floorpan in an occupant compartment 22 of the vehicle body 16. The seat 18 is illustrated as a front seat of the vehicle 14. However, seat 18 could be a rear, a second row, or a third row seat in the vehicle 14.

Seat belt restraint system 12 restrains an occupant (not shown) in seat 18. The seat belt restraint system 12, which is known as a three point system, includes a latch tongue or plate 23 that slides on a belt 24 dividing the belt 24 into a lap belt 25 and a shoulder belt 26. One end of belt 24 (usually the free end of lap belt 25) is anchored to vehicle structure 20. The other end of belt 24 (usually the free end of shoulder belt 26) is connected to the dual level load limiting belt retractor 10. The seat belt restraint system 12 also includes a buckle assembly 28 connected by suitable means such as belt webbing 30 to the vehicle structure 20. Latch plate 23 is engageable and disengageable with the buckle assembly 28. Except for the dual level load limiting belt retractor 10 of the invention, the seat belt restraint system 12 is conventional and known in the art.

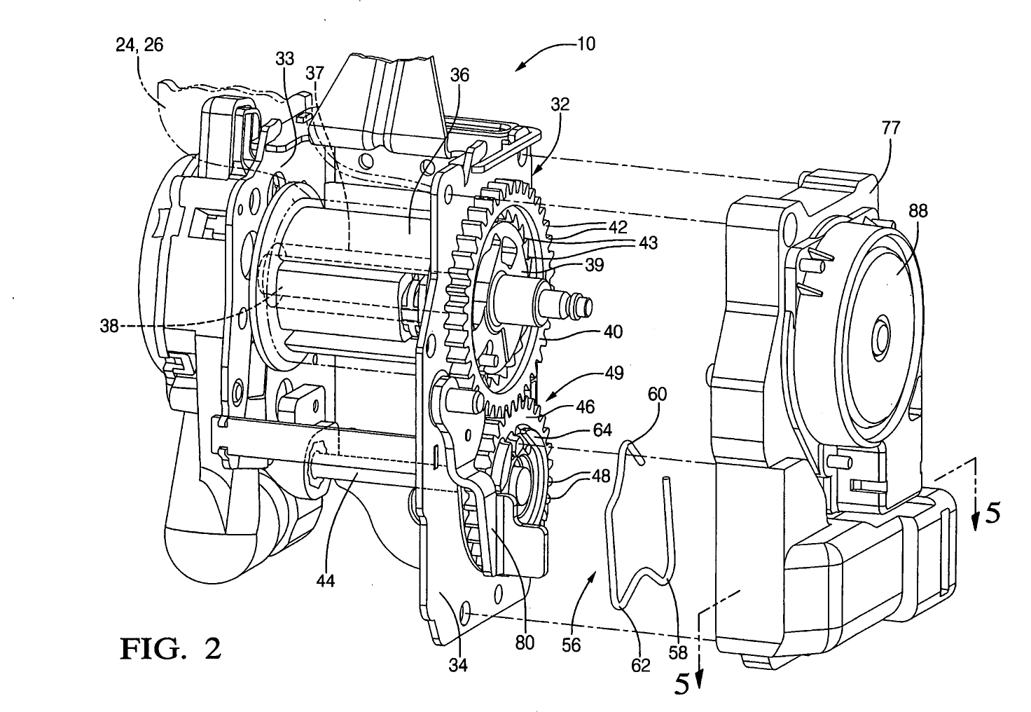

Referring now to FIG. 2, the dual level load limiting belt retractor 10 includes a housing 32 having spaced apart sidewalls 33 and 34 and a belt reel or take-up spool 36 disposed between the sidewalls 33 and 34. Belt 24, shown in phantom, is connected to spool 36 by suitable means such as a slot (not shown) in the take-up spool 36 and a bar (not shown) through a loop (not shown) at the free end of the shoulder belt 26 cooperating with the slot. The dual level load limiting belt retractor 10 includes a first, high level torsion bar 38 extending through a passageway 37 of the take-up spool 36. The first, high level torsion bar 38 has one end rotatably mounted in an aperture of sidewall 33 and an opposite end connected to a locking bobbin 39 that is rotatably mounted directly or indirectly in an aperture of sidewall 34 such that the first, high level torsion bar 38, locking bobbin 39, and take-up spool 36 are rotatable relative to the housing 32.

The first, high level torsion bar 38 has one end fixed to the take-up spool 36 and an opposite end fixed to the locking bobbin 39 and is a constant force limiting member that deforms inside the take-up spool 36 to absorb energy as explained below. The first, high level torsion bar 38 serves as a means to provide a high level of load limiting, such as for example approximately four kilonewtons (4 kN) to approximately six kilonewtons (6 kN), for resisting paying-out belt 24 when belt retractor 10 is locked. Housing 32 is attached by suitable means (not shown) to either the vehicle body 16 or the seat 18. The free end of shoulder belt 26 is connected to and wrapped around the take-up spool 36 to take up slack in belt 24.

The dual level load limiting belt retractor 10 also includes a retractor spring (not shown) disposed about one end of the first torsion bar 38. The retractor spring is of a spiral type having one end attached to the first torsion bar 38 and an opposite end connected to the housing 32 as known in the art. The retractor spring may be enclosed by a spring housing (not shown) attached to the sidewall 34 of the housing 32. The retractor spring has a predetermined torque or tension and urges the first torsion bar 38, locking bobbin 39, and take-up spool 36 in a predetermined direction (clockwise, as shown in FIG. 2) to wind the shoulder belt 26 up onto the take-up spool 36. The retractor spring is conventional and known in the art.

The locking bobbin 39 is rigidly or fixedly attached to and disposed about the end of the first torsion bar 38. The bobbin 39 is generally cylindrical in shape with a generally circular cross-sectional shape and is preferably made of a metal material such as aluminum. Bobbin 39 is concentrically attached and secured to the take-up spool 36 by suitable means such as staking or press-fitting.

The dual level load limiting belt retractor 10 also includes a first, high-level gear 40 disposed about one end of the bobbin 39 outside of the sidewall 34 of housing 32. The first gear 40 is generally circular in shape and has a plurality of external circumferentially spaced teeth 42. The first gear 40 also has a plurality of internal, circumferentially spaced ratchet teeth 43. Locking bobbin 39 and the end of the first torsion bar 38 to which the locking bobbin 39 is attached rotate together as a unit. Locking bobbin 39 may rotate freely with respect to the first gear 40.

The dual level limiting belt retractor 10 includes a second, low level torsion bar 44 having one end fixed to sidewall 33 of the housing 32 and an opposite end extending through an aperture (not shown) of sidewall 34. The axis of the second low level torsion bar 44 is parallel to and spaced laterally from the axis of the first, high level torsion bar 38. The second low level torsion bar 44 serves as a means to provide a low level of load limiting, such as for example approximately two kilonewtons (2 kN) to approximately three kilonewtons (3 kN), for resisting paying-out belt 24 when belt retractor 10 is locked. The one end of the second torsion bar 44 is fixed to the housing 32 by any suitable means.

The dual level load limiting belt retractor 10 further includes a second, low-level gear 46 rigidly or fixedly attached to and disposed about the other end of the second torsion bar 44. The second gear 46 is disposed outside of the sidewall 34 of housing 32 on the same side as the first gear 40. The second gear 46 is generally circular in shape and has a plurality of external circumferentially spaced teeth 48 that mesh with the external teeth 42 of first gear 40. Second gear 46 is secured onto the second torsion bar 44 by suitable means such as staking or press-fitting. Second gear 46 and the end of the second torsion bar 44 to which second gear 46 is attached, rotate together as a unit.

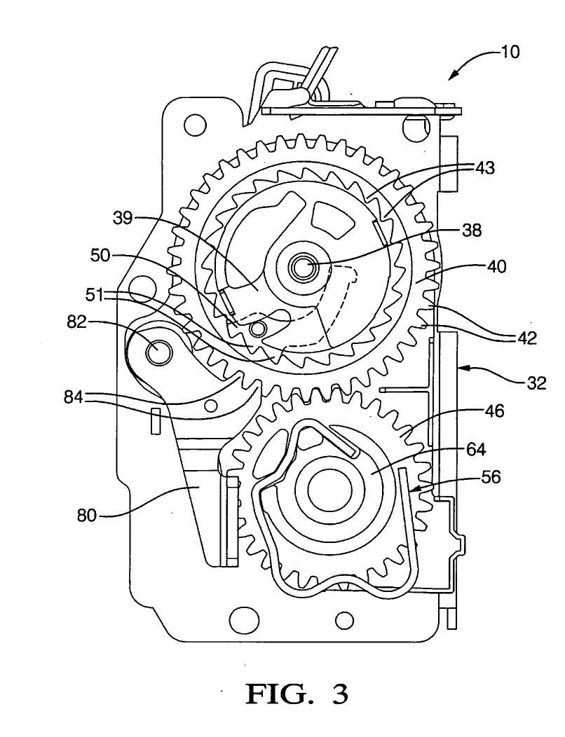

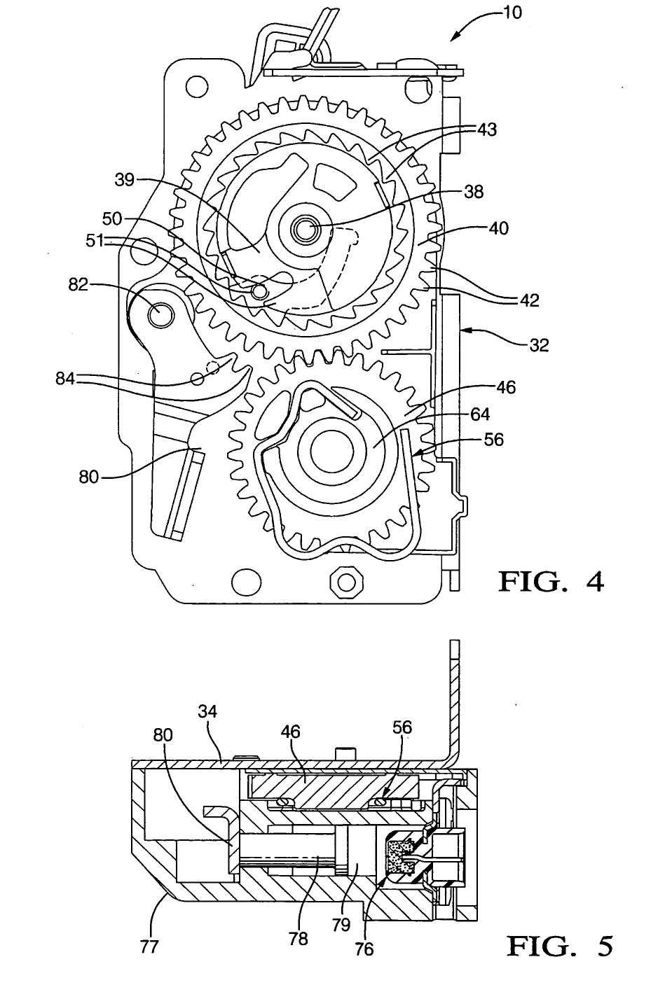

The dual level load limiting belt retractor 10 includes a switch mechanism, generally indicated at 49, cooperating with the first gear 40 and the second gear 46 for switching operation from a first high level of load limiting to a second low level of load limiting. Switch mechanism 49 includes a locking pawl 50 moveably connected to bobbin 39. Pawl 50 has at least one but, preferably a plurality of teeth 51 spaced circumferentially for engagement with the internal teeth 43 of the first gear 40 as best shown in FIGS. 3 and 4. The pawl 50 and bobbin 39 rotate together as a unit with the pawl 50 usually held away from the teeth 43 of the first gear 40 by suitable means such as a spring (not shown).

The switch mechanism 49 includes a lock arm 80 pivotally attached to the sidewall 34 of housing 32 by a pivot pin 82. Lock arm 80 has at least one but may have a pair of projections 84 that engage the external teeth 42 of the first gear 40. First gear 40 acts as a detent member when the lock arm 80 is engaged with gear 40.

The dual level load limiting belt retractor 10 also includes a gas generator 76 secured to a side cover 77 that is attached to the sidewall 34 over the gears 40 and 46 and the lock arm 80 as best shown in FIG. 5. The gas generator 76 is a pyrotechnic device similar to that used to ignite inflators in inflatable restraint systems (e.g. a squib) to expel a gas. The gas generator 76 is connected to a source of power such as a controller (not shown) for activating the pyrotechnic device to expel the gas. The dual level load limiting belt retractor 10 includes a piston or shaft 78 disposed in a cylinder 79 of the side cover 77 that contains the gas generator 76. The piston 78 is generally cylindrical in shape with a generally circular cross-sectional shape for sliding movement in the cylinder 76 and preferably made of a metal material such as steel. The gas expelled by the pyrotechnic device of the gas generator 76 moves the piston 78 axially to engage and pivot the lock arm 80 from the engaged position of FIG. 3 to the disengaged position of FIG. 4. Alternatively, the gas generator 76 may be a stored compressed gas used with an electrical trigger in place of a pyrotechnic device.

The dual level load limiting belt retractor 10 further includes a vehicle or belt sensing mechanism 88 connected by suitable means to side cover 77 of housing 32 and operatively connected to the locking pawl 50. Upon receiving an initiating signal such as a predetermined vehicle deceleration or length of belt payout, the sensing mechanism 88 actuates the pawl 50 to engage the internal ratchet teeth 43 and lock the take-up spool 36 against rotation in the pay-out direction as shown in FIGS. 3 and 4. The sensing mechanism and operation of the locking pawl 50 are conventional and known in the art.

The dual level load limiting belt retractor 10 may include a pretensioner (not shown). The torsion bars 38 and 44 are linked through a gear train comprising meshing gears 40 and 46 but the gear train may include an intervening gear or gears.

In operation, an occupant (not shown) grasps the latch plate 23 and pulls on the lap belt 24 and shoulder belt 26 unwinding or paying out the shoulder belt 26 from the take-up spool 36. The occupant engages the latch plate 23 with the buckle assembly 28 whereupon the take-up spool 36 is automatically wound up to restrain the occupant in the seat 18. During normal vehicle operation, the take-up spool 36 can be rotated in the housing 32 in the pay-out direction for comfort adjustment and the like.

When the vehicle 14 experiences a rapid deceleration, the seat occupant moves forward and places a load on the belt 24 that is attached to the dual level load limiting belt retractor 10 at one end. The sensing mechanism 88 responsive either to a rapid vehicle deceleration of a predetermined level or a rapid pay-out of a predetermined length of belt 24, actuates and moves the locking pawl 50 to engage the teeth 51 with the internal teeth 43 of the first gear 40 which is locked to the housing 32 by lock arm 80. The belt retractor 10 is thus locked and the take-up spool 36 cannot rotate in the pay-out direction unless sufficient belt force is applied. Locking is nearly instantaneous.

As the seat occupant moves forward placing a load on the belt 24 after the belt retractor is locked, the belt 24 can be pulled from the locked take-up retractor against a high level of resistance by twisting the first high level torsion bar 38 between the end (near the side 33 of the housing 32) that is locked to the take-up spool 36 and the end that is locked to the first gear 40 that is locked to the housing 32. This twist allows limited rotation of the take-up spool 36 while absorbing energy of the forward moving seat occupant. In the process, the first high level torsion bar 38 is permanently deformed. Such bars are normally designed to permit many twists before fracture.

When a low level of load limiting is required, the gas generator 76 is fired which moves the piston 78 to pivot the lock arm 80 and release the lock arm 80 from the first gear 42. This allows rotation of the first gear 40. However, the first gear meshes with the second gear 46 which has a low level of resistance to rotation in the pay-out direction due to the low level torsion bar 44. The second, low level torsion bar 44 is rotationally fixed by the side wall 33 of housing 32 at one end. Thus, the rotation of the take-up spool 36 about the first torsion bar 38 is transferred through the gear train to the second torsion bar 44 which responds by twisting between the end of the second torsion bar 44 attached to the second low level gear 46 and the opposite end attached to the side wall 33 of the housing 32. Because the second torsion bar 44 has a low level of load limiting, the second torsion bar 44 twists before the first torsion bar 38, resulting in a low level of load limiting provided to the seat occupant. In this phase of operation, the second low level torsion bar 46 is permanently deformed, absorbing more energy of the forward moving seat occupant. As indicated above, such bars are normally designed to permit many twists before fracture. The locking arm 80 may be disengaged by the squib at any time determined by a controller (not shown) to switch from a high level of load limiting to a low level of load limiting by allowing the gear train to rotate under belt load and allow the seat belt 24 to payout by twisting the second torsion bar 44.

The dual level load limiting belt retractor 10 includes the lock arm 80 and a detent member, which may be an integral part of gear 42, gear 46, a gear therebetween or a separate member attached to any of these gears. The dual level load limiting belt retractor 10 may use other locking means such as a lock pin instead of a lock arm.

The dual load limiting belt retractor as thus far described is known more or less from U.S. Pat. No. 6,648,260 B2 granted to James Lloyd Webber et al. Nov. 18, 2003, as discussed above.

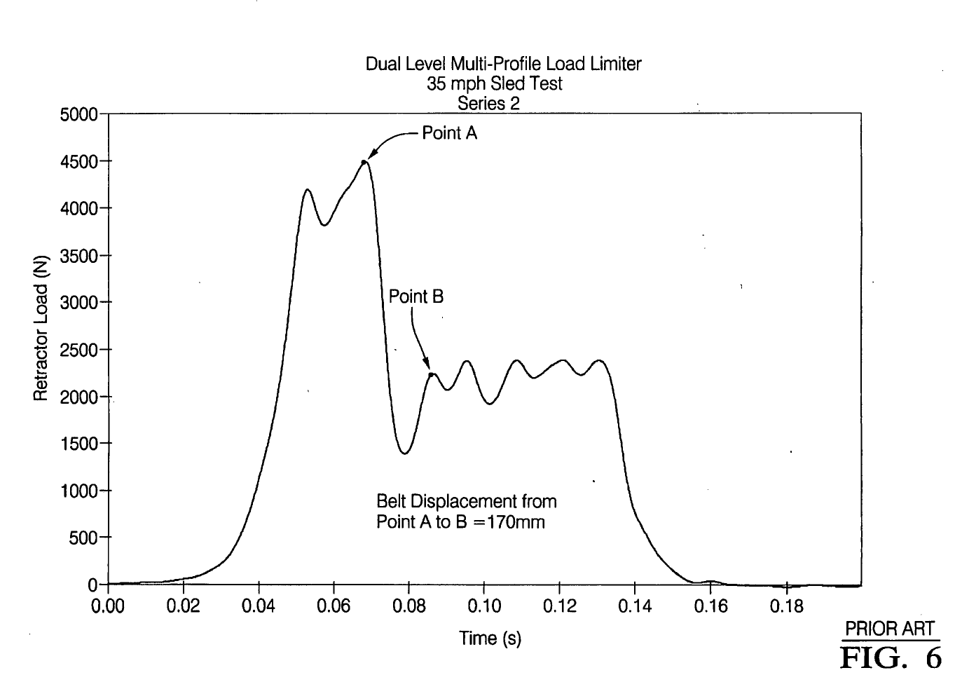

FIG. 6 is a chart showing the retractor load and belt displacement over time of a typical known seat belt retractor arrangement of the type discussed above. In this known arrangement, the retractor load experiences a dip when the retractor switches from the high level of load limiting to the low level of load limiting. This dip allows a belt displacement of about 170 mm with little energy absorption during the approximately 16 millisecond that the retractor switches operation.

This invention provides an auxiliary load limit mechanism indicated generally at 56 to reduce the dip when the operation is switched from the high level to the low level load limiting operation.

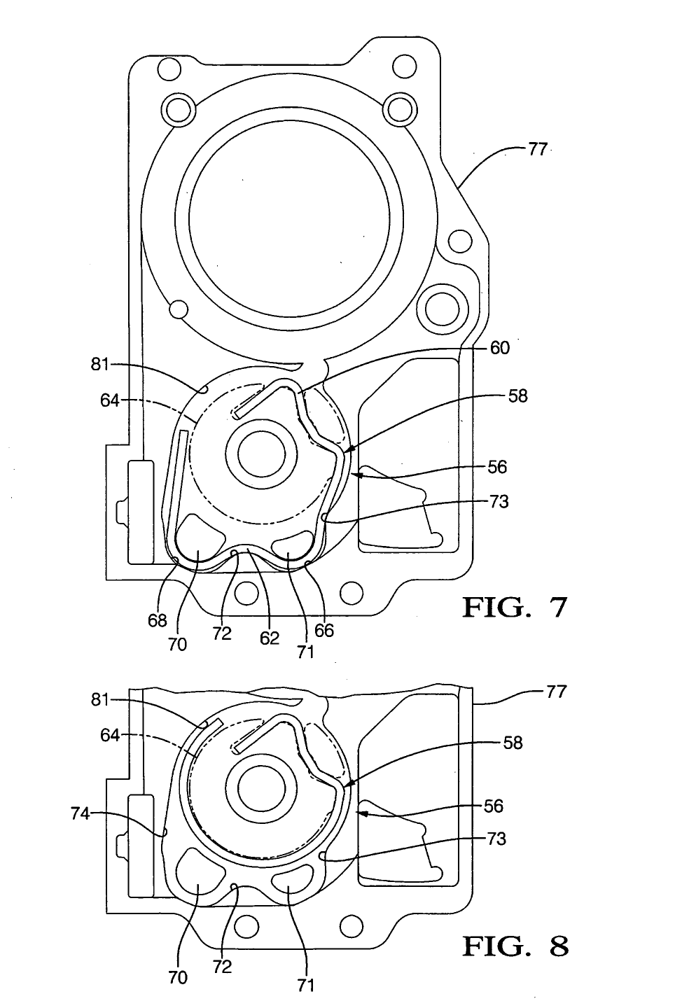

Referring now to FIGS. 2, 7 and 8, the auxiliary load limit mechanism 56 comprises a generally C-shaped wire 58 having a hook-like mounting portion 60 at one end and an undulating trailing portion 62 as shown in FIGS. 2 and 7. The hook-shaped mounting portion 60 is attached to an integral hub 64 of the second low level gear 46 that is disposed in a cavity 81 of side cover 77. Trailing portion 62 which is generally serpentine or undulating weaves through a fixed sinuous passage of the side cover 77, comprising two spaced, curved passages 66 and 68 that are formed by baffles 70 and 71 in side cover 77 in conjunction with convex bumps or anvils 72 and 73 of the peripheral wall 74 of cavity 81 in side cover 77.

C-shaped wire 58 serves as a means to provide an auxiliary or supplementary level of load limiting, such as for example approximately seven tenths kilonewtons (0.7 kN) to approximately one and half kilonewtons (1.5 kN).

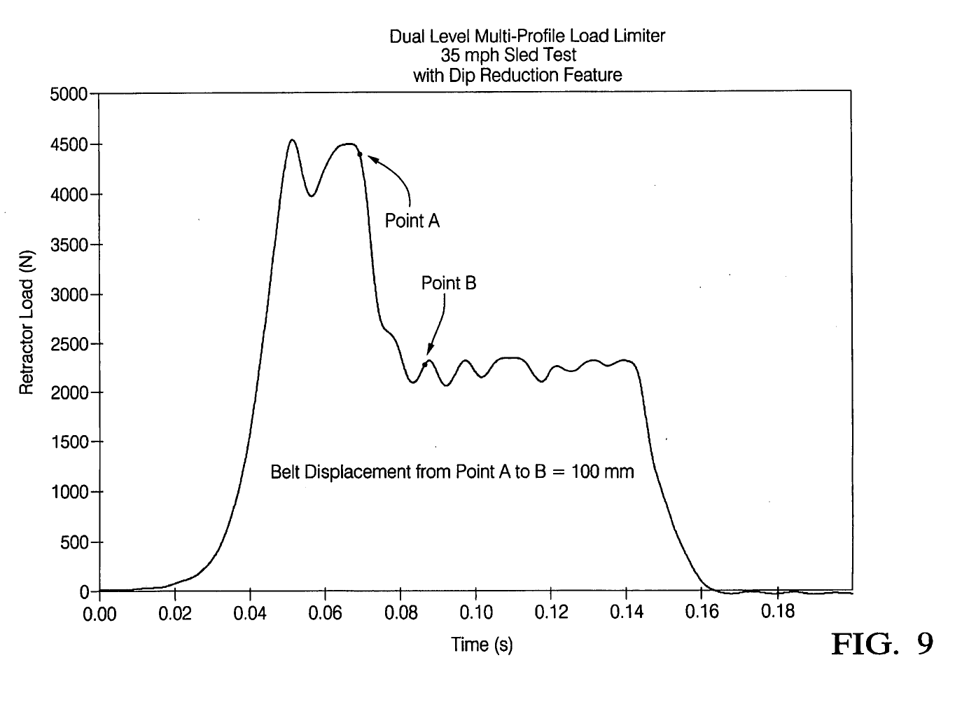

When retractor 10 switches from the high level resistance of torsion bar 38 to the low level resistance of torsion bar 44, by unlocking the gear train comprising gears 40 and 46, gear 46 begins to rotate in the pay-out direction immediately and torsion bar 44 immediately twists elastically. This initial elastic deformation causes the dip noted above in the operation of prior art dual level belt retractor and shown in FIG. 6. However, in the belt retractor 10 of the invention, rotation of low gear 46 also pulls the undulating trailing portion 62 of wire 58 through the curved passages 66 and 68 bending the undulating trailing portion 62 into the new generally part-circular shape shown in FIG. 8. Thus wire 58 immediately resists rotation of the second low level gear 46 which in turn resists rotation of take-up spool 36 upon initial rotation of the second, low level gear 46. This added resistance or load acts during the transition from high load level operation to low load level operation and removes the dip as shown in FIG. 9. FIG. 9 shows that very little, if any, dip in the retractor load when the retractor is switched from high load level operation to low load level operation and a 0.063 inch diameter soft SAE 302 stainless steel wire is used. In the sample tested, this elimination of the dip decreases the belt displacement during load level switching from 170 m to 100 mm which is an improvement of about 41%. Of course, the size and material of the wire 58 can be changed to increase or decrease the added resistance as needed. Furthermore, while a round wire 58 is preferred for economy and a packaging advantage, a deformable strip or band could be used in place of the wire with suitable modifications to cavity 81.

The baffles 70 and 71 are radially spaced from the integral hub 64 to provide a space for the bent part circular wire 58 after the first rotation of the integral hub 64 as shown in FIG. 8. Thus the wire 58 does not provide any appreciable resistence once the low level torsion bar 44 is permanently deformed by the initial pull through the fixed sinuous passage of side cover 77.

The present invention has been described in conjunction with a seat belt restraint system. However, the dual level load limiting belt retractor may be used in any system where a dual level load limiting is desired. Moreover, while the retractor itself is described in connection with first and second torsion bars, the auxiliary load limit mechanism can be used in dual level load limiting belt retractors where the high level and low level resistences are provided by other means which exhibit a dip in the switching operation. In other words, many modifications and variations of the present invention are possible in light of the above teachings. Therefore, within the scope of the appended claims, the present invention may be practiced other than as specifically described.

1. A dual level load limiting belt retractor comprising:
a housing having a rotatable take-up spool connected to a belt for winding the belt onto the take-up spool and paying-out the belt from the take-up spool,
a lock for locking the take-up spool against rotation in a pay-out direction,
a first torsion bar operatively connected to the housing at one end and to the take-up spool at the other end to provide a high level load limit for resisting paying-out the belt when the take-up spool is locked;
a second torsion bar operatively connected to the housing at one end and to the take-up spool at the other end to provide a low level load limit for resisting paying-out the belt when the take-up spool is locked, said low level load limit being less than the high level load limit;
a switching mechanism operatively cooperating with said first torsion bar and said second torsion bar to switch from the high level load limit to the low level load limit; and
an auxiliary load limit mechanism for resisting paying-out the belt when the take-up spool is locked, the auxiliary load limit mechanism being operative when switching from the high level load limit to the low level load limit to supplement the low level load limit at least during the initial operation of the low level load limit.

2. The dual level load limiting belt retractor as defined in claim 1 wherein the auxiliary load limit mechanism comprises a wire that is attached to the low level torsion bar at one end and that has an undulating portion that is disposed in a fixed sinuous guide.

3. The dual level load limiting belt retractor as defined in claim 1 wherein the auxiliary load limit mechanism comprises a bendable generally C-shaped wire that is attached to the low level torsion bar at one end to move therewith, the bendable generally C-shaped wire having an undulating trailing portion that is disposed in a fixed sinuous guide, the undulating trailing portion being permanently reshaped as the wire is pulled through the fixed guide.

4. The dual level load limiting belt retractor as defined in claim 3 wherein the wire has a circular cross section.

5. The dual level load limiting belt retractor as defined in claim 3 wherein the fixed sinuous guide comprises a plurality of curved passages.

6. The dual level load limiting belt retractor as defined in claim 4 wherein the fixed sinuous guide comprises a plurality of curved passages permanently bending the wire into a generally part circular shape.

7. The dual level load limiting belt retractor as defined in claim 6 wherein the curved passages are formed by a plurality of baffles in conjunction with a plurality of convex anvils that are part of a peripheral wall of a cavity.

8. A dual level load limiting belt retractor comprising:
a housing having a rotatable take-up spool connected to a belt for winding the belt onto the take-up spool and paying-out the belt from the take-up spool,
a lock for locking the take-up spool against rotation in a pay-out direction,
a first torsion bar operatively connected to the housing at one end and to the take-up spool at the other end to provide a high level load limit for resisting paying-out the belt when the take-up spool is locked;
a second torsion bar operatively connected to the housing at one end and to the take-up spool at the other end to provide a low level load limit for resisting paying-out the belt when the take-up spool is locked, said low level load limit being less than the high level load limit;
a switching mechanism operatively cooperating with said first torsion bar and said second torsion bar to switch from the high level load limit to the low level load limit; and
an auxiliary load limit mechanism for resisting paying-out the belt when the take-up spool is locked, the auxiliary load limit mechanism having a bendable generally C-shaped wire of circular cross section that is attached to the low level torsion bar at one end via a hub so as to move with the low level torsion bar, the bendable generally C-shaped wire having an undulating trailing portion that is disposed in a fixed sinuous guide so that the undulating trailing portion is permanently reshaped as the wire is pulled through the fixed sinuous guide when switching from the high level load limit to the low level load limit to supplement the low level load limit during an initial operation of the low level load limit,
the fixed sinuous guide including a plurality of curved passages that are formed by a plurality of baffles in conjunction with a plurality of convex anvils that are part of a peripheral wall of a cavity,
the curved passagaes permanently deforming the wire into a generally part circular shape as the wire is pulled through the curved passages, and
the baffles being spaced from hub to provide space for the wire after it is deformed into the generally part circular shape.

9. A dual level load limiting belt retractor comprising:
a housing having a rotatable take-up spool connected to a belt for winding the belt onto the take-up spool and paying-out the belt from the take-up spool,
a lock for locking the take-up spool against rotation in a pay-out direction,
first means to provide a high level load limit for resisting paying-out the belt when the take-up spool is locked;
second means to provide a low level load limit for resisting paying-out the belt when the take-up spool is locked, said low level load limit being less than the high level load limit;
a switching mechanism operatively cooperating with said first means and said second means to switch from the high level load limit to the low level load limit; and
an auxiliary load limit mechanism for resisting paying-out the belt when the take-up spool is locked, the auxiliary load limit mechanism being operative when switching from the high level load limit to the low level load limit to supplement the low level load limit during the initial operation of the low level load limit.

10. The dual lever load limiting belt retractor as defined in claim 9 wherei the auxiliary load limit mechanism comprises a bendable generally C-shaped wire that is attached to the low level torsion bar at one end to move therewith, the bendable generally C-shaped wire having an undulating trailing portion that is disposed in a fixed sinuous guide, the undulating trailing portion being permanently reshaped as the wire is pulled through the fixed guide.

11. The dual level load limiting belt retractor as defined in claim 10 wherein the wire has a circular cross section.

12. The dual level load limiting belt retractor as defined in claim 10 wherein the fixed sinuous guide comprises a plurality of curved passages that are formed by a plurality of baffles in conjunction with a plurality of convex anvils that are part of a peripheral wall of a cavity which permanently bend the wire into a generally part circular shape when the wire is pulled through the fixed sinuous guide.
